(19) United States
(12) Patent Application Publication
(10) Pub. No.: US 2004/0030595 A1
(43) Pub. Date: Feb. 12, 2004

(54) Method of advertisement using online games

(76) Inventor: Jong Hyouk Park, ;Seoul (KR)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/296,918

(22) PCT Filed: Feb. 1, 2001
(86) PCT No.: PCT/KR01/00136

(30) Foreign Application Priority Data
Jun. 2, 2000 (KR) 200/30512
Aug. 30, 2000 (KR) 2000/50936
Sep. 28, 2000 (KR) 2000/57142
Nov. 10, 2000 (KR) 2000/66899

(51) Int. Cl. G06F 17/60

(52) U.S. Cl. 705/14; 463/11

(57) ABSTRACT

The present invention relates to an advertising method using various kinds of on-line games such as Korean playing cards and occidental cards, and a business model of an on-line game service through a connection between an on-line service company and a conventional company, that is, an on-line service company and a member company. In particular, the present invention relates to a business model wherein a real transaction between a member and the member company can be induced in a manner that a game site grants a specific member a qualification to take part in the game and allows the specific member to take part in the game upon request of the member company, and wherein services for promoting advertising effectiveness are provided by inserting a plurality of distinctive advertisements into game characters according to accumulation of game points.

### FIELD OF THE INVENTION

The present invention relates to an advertising method using various kinds of on-line games such as Korean playing cards and occidental cards, and a business model of an on-line game service through a connection between an on-line service company and a conventional company, hereby called the member company. The present invention relates in particular to a business model wherein a real transaction between a member and a member company can be induced in a manner that a game site grants only a specific member a qualification to take part in the game, and allows the specific member to take part in the game upon request of the member company. Further, services for promoting advertising effectiveness are provided by inserting a plurality of distinctive advertisements, which are distinguishable in accordance with accumulation of game points, into game characters.

### BACKGROUND OF THE INVENTION

The present invention relates to an advertising method using various kinds of on-line games such as Korean playing cards and occidental cards, and a method for creating business effectiveness through connecting an on-line game company and a conventional company. In particular, the present invention is related to a method for providing services whereby a game site grants a specific member a qualification to take part in the game and allows the specific member to take part in the game upon request of a member company. Consequently, various advertisements, distinguishable in accordance with accumulation of game points, can be inserted into game characters.

Owing to the recent rapid development and spread of network communications and internet technologies, a large number of sites which provide on-line game services using internet networks, have been opened and operated.

However, the sites that insert the advertisements into a game screen in the process of the game are in limited numbers, and they have relied on banner advertisements having an extremely insignificant effectiveness of advertising, even in view of inserting the advertisements therein. Therefore, it was difficult to cause internet users to recognize what the member company wished to publicly inform, and there were many management difficulties involving the sites that provide game services at a cost or for free.

### SUMMARY OF THE INVENTION

The present invention is contemplated to solve the above problems. The object of the present invention is to highlight concerns of the member to the member company or the advertisement thereof and to induce a real transaction between the member and the member company. This should be done in such a manner that the web sites present game points to the member designated by the member company or grant the member a qualification to take part in the game upon request of the member company. Furthermore, another object of the present invention is to provide an advertising method wherein distinctive advertisements are inserted into game characters according to accumulation of the game points provided on-line and are easily recognized by the game user.

In order to achieve the above objects of the present invention, a business-linked advertising method using an on-line game, into which the advertisement is inserted by an on-line game system including a main server 100 for processing data and controlling apparatuses required for operating a game site, a game server 110 for performing game processing so as to provide game environments such that the members can play the online game with one another, an advertising database 120 for storing advertising data inserted in a homepage and a game screen in progress of the game site, a database 130 for storing member information and various data required for the operation of the site, and a matching portion 111 for inserting the advertisements into the game screen through checking the state of progress of the game and searching the advertising database in order to insert the advertisements into the game screen in progress, whereby operating profits can be created through connection between on-line service and conventional member companies, comprises the steps of: inquiring by the main server as to whether the member company grants a specific member a qualification to take part in the game when the member company logs in, and storing inquired results in the database; checking by the main server as to whether there is a request by the member company for granting the member a qualification to take part in the game when the member logs in to the web site; providing by the main server information on the member and on the game in which the member can take part; when the member selects the game in which the member wants to take part, connecting the member with the game server by the main server; reflecting by the game server the advertisement stored in the advertising database onto the game screen in progress by means of the processing of the matching portion when the game starts; checking by the game server as to whether the game comes to an end, and checking by the main server as to whether game points should be given to the member.

Furthermore, the step of checking by the main server whether there is a request of the member company for granting the member the qualification to take part in the game comprises a step of storing by the main server game points information in member information data of the database when the member company has requested the main server to give the specific member the predetermined game points.

### BRIEF DESCRIPTION OF THE DRAWINGS

FIG. 1 is a constitutional view of a network according to the present invention.

FIG. 2 is a flowchart showing the process of an advertising method using an on-line game in accordance with the present invention.

### DETAILED DESCRIPTION OF THE PREFERRED EMBODIMENTS

Hereinafter, a preferred embodiment of the present invention will be explained with reference to the drawings.

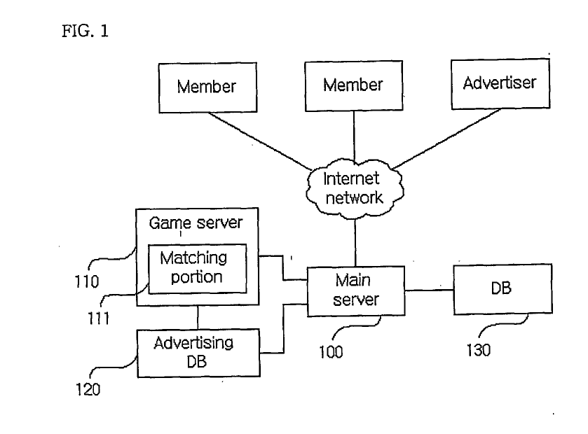

FIG. 1 shows the constitution of a network according to the present invention. A member and a member company connect via the internet network with a main server 100 that processes data and controls apparatuses required for the operation of a game site. The main server again connects with a game server 110 for providing a game screen in progress so that members can play on-line games with one another and for performing game processing in order to process data inputted by the members. It further connects with an advertising database 120 for storing advertising data inserted in both the homepage and the game screen in progress of the game site. It finally connects with a database 130 for storing member information and various other data required for the operation of the site.

Furthermore, the game server 110 includes a matching portion 111 for inserting an advertisement into a character of the game screen through the checking of the progress of the game and the search of the advertising database in order to insert the advertisement in the game screen in progress.

The processing of the matching portion will be explained more specifically as follows. If member A, who has more game points, plays the game with member B who has relatively less game points, the matching portion inserts the advertisements c and d in individual characters of the members A and B, respectively. The matching portion then also checks the progress state of the game. In particular, after checking the game points according to the game progress and searching appropriate advertising data from the advertising database, the matching portion inserts and deletes the advertisements into and from the characters, respectively.

Therefore, the advertisements inserted in the characters when the game is in progress are not always inserted in the same way. That is, the advertisements can be varied in accordance with the game progress, and the number of advertisement types can be also varied.

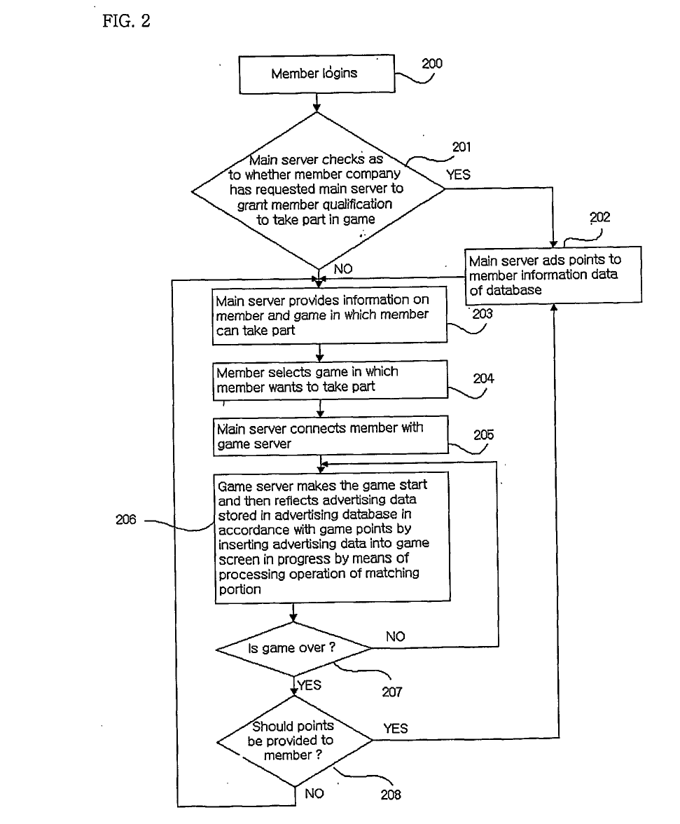

FIG. 2 is a flowchart showing a process of an advertising method using online game and a method of connecting the business between an on-line game company and the other companies in accordance with the present invention.

First, the member logs in to a web site after going through a member authentication procedure by using his or her ID and password (step 200). After the member logs in to the web site, the main server searches for information on the member from the database and checks whether the member has the necessary qualification to take part in the game (step 201). After confirmation of the member company, the main server updates member information data in the database and stores information concerning the qualification to take part in the game or game points therein, whenever there is a request of the member company (step 202). At this time, requirements that the member company requests the web site to add the points of the member can be set to various levels. For example, when the member buys a product of the member company, the member company sets a predetermined proportion in accordance with the amount of purchase and the points corresponding thereto and requests the web site to add the points to the member's database.

Then, the main server provides the member with the member information including the member points and game information (game list) in which the member can take part (step 203). When the member selects the game in which the member wants to participate (step 204), the main server connects the member with the game server (step 205). At this time, the member, as a client, becomes a client of the main server before taking part in the game, whereas the member becomes a client of the main server and the game server after taking part in the game.

Next, the game server starts the game and reflects the advertising data stored in the advertising database on the game. In accordance with the game points, the game server inserts the advertising data into the game in progress by means of processing operation of the matching portion (step 206). Advertising modes such as the type and number of advertisements to be inserted, and the amount of repetitions of the advertisement can be determined by a contract between the web site and the member company, and the type and number of the advertisement to be inserted can be varied in accordance with the number of the participants and characters, etc. Therefore, the matching portion checks the information on the advertising modes as well as the advertising data stored in the advertising database, and thus can update and repeat the advertisement in real time even when the game is in progress.

When the game comes to an end (step 207), the main server determines whether to give the member the points in accordance with a predetermined criterion, based on game result data provided by the game server (step 208), and adds the points to the member's database if the criterion is appropriate. The process then returns to step 203.

And, in the process of inserting the advertisement while the game is in progress, the matching portion can search the advertisements corresponding to characteristics of the member, such as his or her age and sex, based on the member information. It can then match them with the game screen. A technique such as html or flash can be used in the inserted advertisements. It is also possible for the member to visit a pertinent web site by linking the site relevant to the advertisements and loading an additional browser window while the game is in progress.

As another embodiment of the present invention, services can be provided for giving points to the member by means of an agreement or contract between the game site and the member company.

In such a case, the main server checks as to whether the member company has requested the main server to grant the specific member a qualification to take part in the game (step 201), and updates the member information data of the database upon the request of the member company. Furthermore, at step 202 of storing the information concerning the qualification to take part in the game, the main server updates the member information data of the database, and adds the points information to the database when the member company requests the main server to add predetermined points to the specific member.

In addition, the member company does not necessarily have to insert the advertisement. Since various business types including service, manufacturing, freelance profession, sales, etc. can participate in the game site, through an agreement or contract therewith, as a member company, the user can take part in the game by the requests of various member companies whom the user has dealings with during everyday life.

### INDUSTRIAL APPLICABILITY

According to the present invention as described above, by providing the advertising method of inserting the advertisement into a portion of the game character while the on-line game is in progress, the advantageous effectiveness of the advertisement is distinguishable from that of the internet banner advertisement or the advertisement using conventional mass media. Further, there are other effects of the advertisement that concern for the member by the member company can be induced, since game services, including the service for giving the member the qualification for participating in the game and the game points, are constructed such that the game points are added in the web site or the qualification to take part in the game is granted upon on-line request of the on-line or off-line member company. In particular, there is a further advantage in that real transactions of the member with the member company can be efficiently induced since the points and the qualification to take part in the game are granted by the transaction.

1. An advertising method using an on-line game, into which advertisements are inserted by an on-line game system including a main server 100 for controlling apparatuses required for operating a web site providing various kinds of game such as Korean playing cards or occidental cards and for processing relevant data, a game server 110 for performing game processing so as to provide game environments such that members can play the on-line game with one another, an advertising database 120 for storing advertising data inserted in a homepage and a game screen in progress of said game site, a database 130 for storing information on said member and various data required for the operation of said site, and a matching portion 111 for inserting said advertisement into said game screen through check of a progress state of said game and search of said advertising database in order to insert said advertisements into said game screen in progress, comprising the steps of:
when a member company logs in to said web site, requesting, by said main server, said member company to appoint said member as a specific member who has a qualification to take part in said game and obtains game points;
when said member logs in to said web site, checking by said main server as to whether said member company has requested for granting said member said qualification to take part in said game;
providing by said main server said information on said member and on said game in which said member can take part;
when said member selects said game in which said member wishes to take part, connecting said member with said game server by said main server;
reflecting by said game server said advertisements stored in said advertising database onto a game character of said game screen in progress by means of the processing of said matching portion when said game starts;
checking by said game server as to whether said game comes to an end; and
checking by said main server as to whether said game points should be given to said member.

2. The method as claimed in claim 1, wherein said matching portion inserts said advertisements, which are distinguishable in accordance with said game points, into said individual character of said member, on a conventional on-line game.

3. The method as claimed in claim 1, wherein said method is a business model in which a real transaction between said member and said member company can be induced by granting said member said qualification to use services through an on-line connection with said member company, and said services provided to said member include Korean playing cards, poker, the other on-line games and general information services.
